(19) United States
(12) Patent Application Publication
(10) Pub. No.: US 2006/0027682 A1
(43) Pub. Date: Feb. 9, 2006

(54) Fuel injectors

(75) Inventors: Tsuneaki Aoki, Obu-shi (JP); Toshiro Makimura, Obu-shi (JP)

Correspondence Address: DENNISON, SCHULTZ, DOUGHERTY & MACDONALD, 1727 KING STREET, SUITE 105, ALEXANDRIA, VA, 22314, US

(73) Assignee: Aisan Kogyo Kabushiki Kaisha

(21) Appl. No.: 11/175,276

(22) Filed: Jul. 7, 2005

(30) Foreign Application Priority Data
Aug. 7, 2004 (JP) 2004-201755

(51) Int. Cl. F02M 47/02; F02M 63/00; F02M 51/00; F02M 59/00

(52) U.S. Cl. 239/533.2; 239/88; 239/585.5; 239/585.3

(57) ABSTRACT

The fuel injector may comprise a valve (25) body, a valve (25) seat, a core (21), and a valve (25). The valve (25) body may have a fuel path. The valve (25) seat may be attached to the downstream end of the valve (25) body and have a fuel injection hole. The core (21) may be attached to the valve (25) body. The valve (25) may be slidably disposed within the valve (25) body and be able to reciprocate between an open position and a closed position. The valve (25) may have an armature on one end and a ball on the other end. The upstream end surface of the armature contacts with the downstream end surface of the core (21) when the valve (25) is in the open position. The ball closes off the fuel injection hole in the valve (25) seat when the valve (25) is in the closed position. At least one of the upstream end surface of the armature or the downstream end surface of the core (21) may be partially plated, and recesses and protrusions are preferably formed by the plated regions and the non-plated regions.

### CROSS-REFERENCE TO RELATED APPLICATION

This application claims priority to Japanese Patent Application number 2004-201755, filed on Jul. 8, 2004, the contents of which are hereby incorporated by reference as if fully set forth herein.

### BACKGROUND OF THE INVENTION

1. Field of the Invention

The present invention relates to fuel injectors which may be preferably utilized with internal combustion engines. In particular, the present invention relates to technology concerning the responsiveness of fuel injectors.

2. Description of the Related Art

Known fuel injector comprises a valve body, a valve seat, a core, a valve, a spring, and a solenoid coil. The valve body has a fuel path. The valve seat is attached to the downstream tip of the valve body and has a fuel injection hole. The core is attached to the valve body. The valve is accommodated in the valve body and is able to slide between an open position and a closed position. The valve generally comprises a shaft, a magnetic armature, and a ball. The armature is connected to one end of the shaft. The ball is attached to the other end of the shaft. When the valve is in the open position, the injection hole opens and the upstream end surface of the armature is in contact with the downstream end surface of the core. When the valve is in the closed position, the ball closes the fuel injection hole in the valve seat. The spring applies a bias force on the valve, wherein the bias force pushes the valve in the closed position. The solenoid coil generates an electromagnetic force. When current is supplied to the solenoid coil, the valve moves to the open position as a result of the electromagnetic force acting on the armature. When the current to the solenoid coil is stopped, the valve is moved from the open position to the closed position by the biasing force of the spring.

The fuel injector is supplied with pressurized fuel from a fuel supply line. The fuel which is supplied from the fuel supply line flows into the fuel injector and is injected. Therefore, the upstream end surface of the armature and the downstream end surface of the core are wet with fuel. In this condition, when the valve is to close, or in other words when the upstream end surface of the armature and the downstream end surface of the core are to be separated, a resisting force (hereinafter referred to as a kind of “adhesive force”) is generated, since the velocity of fuel flowing into the gap between the armature and the core is limited. When the adhesive force is generated, the valve does not quickly move to the closed position.

Japanese Laid-Open Patent Publication Nos. 9-310650 and 2003-328891 disclose technology to mechanically form protrusions and recesses at the upstream end surface of the armature in order to prevent a loss of responsiveness when closing the valve due to the adhesive forces.

### BRIEF SUMMARY OF THE INVENTION

In this type of fuel injector, the upstream end surface of the armature and the downstream end surface of the core are generally plated to improve wear resistance. Therefore, when the protrusions and recesses are formed on the upstream end surface of the armature and/or the downstream end surface of the core, the protrusions and recesses are also plated.

When the valve is in the closed position, or in other words when the armature and the core are separated, the distance between the armature and the core is preferably small. To be precise, the armature here means a member made of ferromagnetic material and does not include surface plating. Also, the core here means a member made of ferromagnetic material and does not include surface plating. When the distance between the armature (surface plating being omitted) and the core (surface plating being omitted) is small, greater magnetic attraction force is applied between the armature and the core when the solenoid coil is activated.

When the protrusions and recesses are formed on the upstream end surface of the armature and the upstream end surface of the armature is plated, the depth from the plating surface of the protrusions to the bottom of the recesses on the armature (surface plating being omitted or excluded) is the sum of the plating thickness and the depth of the mechanically formed recessed regions. When the distance between the armature (surface plating being excluded) and the core (surface plating being excluded) is large, the magnetic attraction forces which are generated when the solenoid coil is activated will be lower. If the magnetic attraction forces are low, the responsiveness when the valve is to be opened will be poor. If the spring is weakened in order to accommodate the drop in responsiveness when the valve is to be opened due to the drop in magnetic attraction forces, the responsiveness when the valve is to be closed will be poor, and the ball may not completely close the valve seat.

It is, accordingly, one object of the present teachings to provide improved fuel injectors which can reduce the adhesive forces when the armature and the core are separated without reducing the magnetic attraction forces when the solenoid coil is activated.

In one aspect of the present teachings, fuel injector may comprise a valve body, a valve seat, and a core. The valve body has a fuel path. The valve seat may be attached to the downstream side of the valve body. The valve seat has a fuel injection hole. The core may be attached to the valve body. The fuel injector may further include a valve, a spring, and a solenoid coil. The valve is slidably disposed within the valve body. The valve reciprocates inside the valve body between an open position and a closed position. The valve may include an armature on one end and an injection hole closing member such as a ball on the other end. When the valve is in the open position, the upstream end surface of the armature contacts with the downstream end surface of the core. When the valve is in the closed position, the hole closing member closes the fuel injection hole in the valve seat. The spring may be disposed within the valve body. The spring applies a bias force on the valve which pushes the valve in the closed position. The solenoid coil retracts the valve from the closed position to the open position when current is supplied to the solenoid coil. At least one of the upstream end surface of the armature or the downstream end surface of the core may be partially or sporadically plated. Recesses and protrusions may be formed by the sporadically plated regions and non-plated regions.

Generally, the upstream end surface of the armature and the downstream end surface of the core are plated to improve durability. Therefore, even if recesses and protrusions are formed by the sporadically plated regions and the non-plated regions on either the upstream end surface of the armature or the downstream end surface of the core or both, the distance between the armature (surface plating being excluded) and the core (surface plating being excluded) will not change (i.e., the distance between the ferromagnetic members will not change) as long as the plating thickness is consistent. Therefore, protrusions and recesses formed by the sporadically plated regions will not decrease the magnetic attraction forces. When protrusions and recesses are formed by partially plating at least one of the upstream end surface of the armature or the downstream end surface of the core, the adhesive forces which occur when the armature and the core are separated can be reduced. Therefore, the adhesive forces can be reduced without reducing the magnetic attraction forces.

According to the present specification, the phrase “the core is attached to or in the valve body” does not only mean that the core is directly attached to or in the valve body, but may also mean that the core is attached to or in the valve body through another member. Furthermore, the phrase “the valve is slidably disposed within the valve body” also includes a situation where the valve is partially disposed within the valve body and is able to slide. Furthermore, “plating” is not limited to wet plating by chemical reaction. Dry plating formed by various dry plating methods may be used. Dry plating method may be one of “metal vapor deposition method”, “CVD (chemical vapor deposition)”, “thermal CVD”, “plasma CVD”, “catalyst CVD”, “photo assisted CVD”, “RF plasma enhanced CVD”, “other CVD”, “sputtering”, “ion implantation”, and “plasma ion implantation” may be used. Appropriate thin film forming method may be used to form the plating to obtain protrusions and recesses.

In another aspect of the present teachings, the upstream end surface of the armature or the downstream end surface of the core is provided with a fuel pathway, and at least one of the upstream end surface of the armature or the downstream end surface of the core has a plurality of plated regions. The plated regions may extend radially from the circumference of an opening of the fuel path to the end surface. If the plated regions extend in rays, when the upstream end surface of the armature and the downstream end surface of the core are to be separated (i.e., when closing the valve), fuel will easily flow between the upstream end surface of the armature and the downstream end surface of the core through the non-plated regions (fuel pathway formed by recesses). Therefore, the armature and the core will more easily separate and responsiveness will be improved when the valve of the fuel injector is being closed.

In anther aspect of the present teachings, at least one of the upstream end surface of the armature or the downstream end surface of the core has a plurality of plated regions. Each plated regions is substantially ring shaped and arranged to be substantially concentric. If the ring shaped plating regions are arranged to be substantially concentric, the upstream end surface of the armature or the downstream end surface of the core will contact with the plated regions when the valve is being opened, and a damping effect will occur because of the fuel which is located in the area between the plated regions. The fuel located between the plated regions does not ready escape from the gap between the armature and the core, and this fuel works as a cushion of preventing the hard strong collision of the armature and the core. When this damping effect occurs, open valve bounce (i.e., valve recoil) will be reduced. When open valve bounce is reduced, the fuel injection quantity can be more accurately controlled.

In anther aspect of the present teachings, at least one of the upstream end surface of the armature or the downstream end surface of the core has a plurality of plated regions. Each plated regions is substantially ring shaped and arranged to be substantially concentric. Notches are preferably formed in the inside plated region. The notches may extend in the radial direction.

With this construction, open valve bounce which occurs when the valve is being opened can be reduced because the fuel between the concentric ring shaped plated regions does not ready escape from the gap between the armature and the core. Furthermore, fuel will flow into the area formed between the concentric ring shaped plated regions through the notch formed in the inside plating region, so the armature and the core will easily separate when the valve is being closed, and thus responsiveness will improve when the valve is being closed.

In another aspect of the preset teachings, plating is performed on at least one of the upstream end surface of the armature or the downstream end surface of the core, and the thickness of the plating may also differ. A fuel injector constructed in this manner can minimize adhesive forces without reducing the magnetic attraction forces.

In another aspect of the preset teachings, plating may be partially performed on the upstream end surface of the armature and the downstream end surface of the core. Protrusions and recesses are preferably formed by the plated regions and non-plated regions. The protrusions and recesses on the upstream end surface of the armature and the protrusions and recesses on the downstream end surface of the core may be arranged such that the protrusions of one side and recesses of the other side do not engage together when in contact.

The above mentioned aspects and features may be utilized singularly or, in combination, in order to make improved fuel injector. In addition, other objects, features and advantages of the present teachings will be readily understood after reading the following detailed description together with the accompanying drawings and claims. Of course, the additional features and aspects disclosed herein also may be utilized singularly or, in combination with the above-described aspect and features.

### BRIEF DESCRIPTION OF THE DRAWINGS

FIG. 1 is a vertical cross-section drawing of a fuel injector of a representative embodiment of the present teachings.

FIG. 2 is a side surface view of the valve of the present embodiment.

FIG. 3 is a view in the direction of arrow III-III in FIG. 2.

FIG. 4 shows an example of the contact region shape.

FIG. 5 shows another example of the contact region shape.

### DETAILED DESCRIPTION OF THE INVENTION

In the following, several exemplary embodiments of the invention are described with reference to the accompanying drawings for further explaining particular applications and better understanding of the invention.

A fuel injector 10 according to a representative embodiment of the present teachings will be described while referring to the drawings.

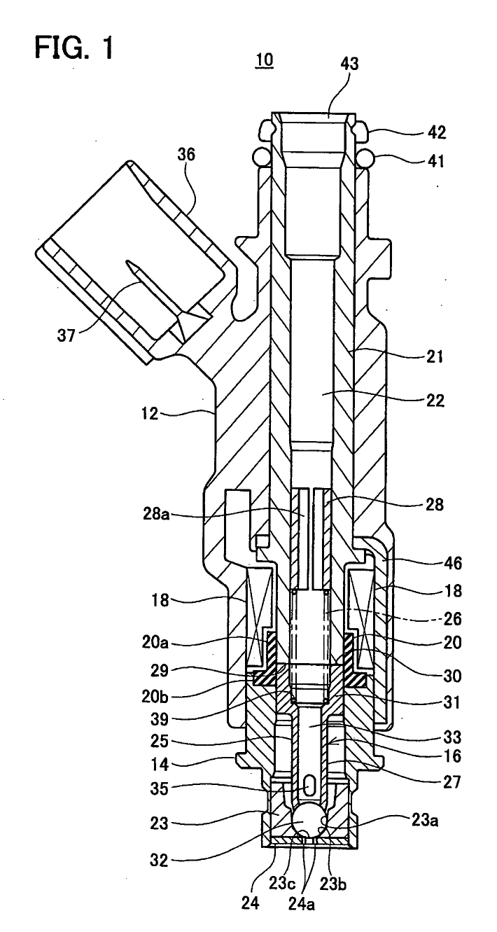

As shown in FIG. 1, a fuel injector 10 comprises a housing 12, a valve body 14, a core 21, a ring 20, a valve mechanism 16, and a solenoid coil 18.

The core 21 has a cylindrical form and is fixed within the housing 12. The core 21 has a fuel path 22 which passes through in the axial direction. The ring 20 is formed as a cylindrical valve body 20a with a lip 20b on the leading edge. The ring 20 is secured to the core 21 such that the leading edge of the core 21 is inserted partway into the valve body 20a. The valve body 14 is inserted partway around the lip 20b of the ring 20 and secured to the ring 20.

A valve seat 23 is inserted and secured in the leading end of the valve body 14. The valve seat 23 is formed with a cylindrical slide hole 23a, a bowl shaped part 23b connected to the slide hole 23a, and an opening 23c which is opened in the bottom of the bowl shape part 23b. A disc shape orifice 24 is preferably welded to the leading end of the valve seat 23. A pair of fuel injection holes 24a is formed in the center region of the orifice 24 in a position which overlaps the opening 23c in the valve seat 23.

The valve body 14 and the core 21 are made of a ferromagnetic material. The ring 20 is made of a nonmagnetic material.

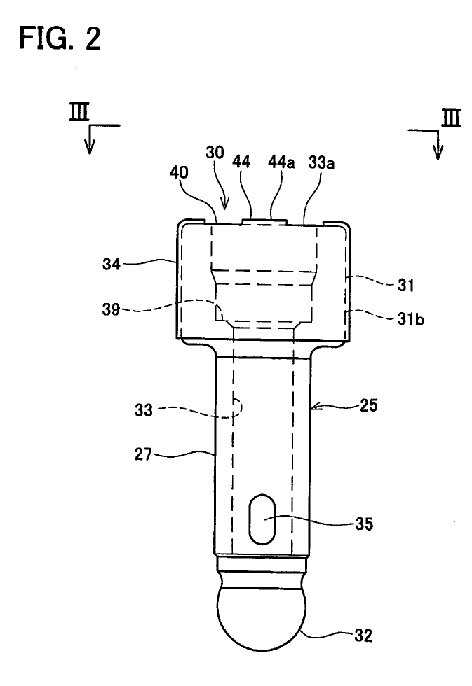

The valve mechanism 16 comprises a valve 25, a spring 26, and an adjuster 28. As shown in FIG. 2, the valve 25 comprises a shaft 27 with a hollow core, an armature 31 which is integrated on the back side of the shaft 27 and a ball 32 which is attached to the leading end of the shaft 27. A fuel path 33 is formed within the armature 31 and the shaft 27, extending in the axial direction. The fuel path 33 is closed on the leading end by the ball 32 and is opened to the outside by opening 33a on the back side. A lip 39 is formed in the fuel path 33 in the armature 31. A side hole 35 which connects the fuel path 33 to the outside is formed in the shaft 27. The armature 31 is made of ferromagnetic material.

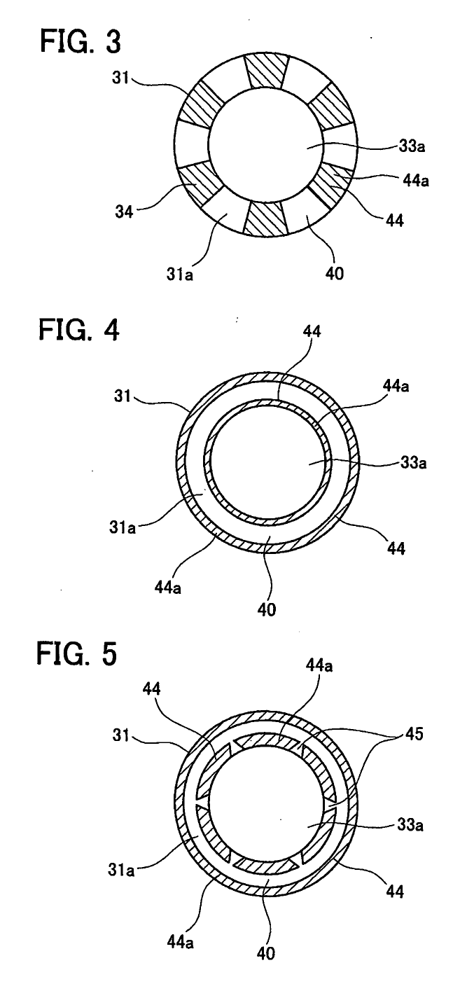

As is clearly shown in FIG. 3, the back surface 30 of the armature 31 is plated partially. Thus, the back surface 30 has protrusions 44 (hereinafter referred to as “plating protrusions 44”) which are formed to be higher by only the thickness of the plating, and recesses 40 (hereinafter referred to as “non-plating recesses 40”) where plating is not present (in FIG. 3, the regions where there is plating protrusions 44 are shown in the figure by hatching). As will be described in detail later, the top surface of the plating protrusions 44 function as the contact surface 44a with the core 21. The plating protrusions 44 and the non-plating recesses 40 are arranged in rays around the opening 33a. That is, the plating protrusions 44 and the non-plating recesses 40 extend radially from the circumference of the opening 33a to the outside edge. Further, the plating protrusions 44 and the non-plating recesses 40 are alternately disposed. The non-plating recesses 40 can be formed by masking those regions when plating 34 is performed.

As shown in FIG. 2, the plating 34 may be performed on the side surface 31b of the armature 31. However, plating on the side surface 31b of the armature 31 is not necessary. Note, in FIG. 2, the plating 34 and plating protrusions 44 are shown in the drawing to be thicker than actual for clarification purposes. The plating 34 and plating protrusions 44 may, for instance, be hardened chrome plating or nickel phosphorous plating. The preferred plating thickness for the plating 34 and plating protrusions 44 is between 6 micrometers and 12 micrometers.

The plating protrusions 44 and the non-plating recesses 40 may be formed by simply masking prior to plating the armature 31. Therefore, according to the invention, manufacturing costs can be reduced when compared to mechanical forming the protrusions and recesses at the back surface 30 of the armature 31.

As shown in FIG. 1, the valve 25 is accommodated in the valve body 14, and in this condition, the armature 31 is guided by the inside surface of the ring 20, and the ball 32 is guided by the slide hole 23a of the valve seat 23. Therefore, the valve 25 is guided in two locations, namely the ring 20 and the valve seat 23, and slides in the axial direction of the fuel injector 10.

The adjuster 28 has a cylindrical form and is press fit into the core 21. A fuel path 28a is formed to pass through the adjuster 28 in the axial direction. The spring 26 is inserted in a compressed condition between the adjuster 28 and the lip 39 of the armature 31. Therefore, the ball 32 of the valve 25 has a biasing force applied by the spring 26, and contacts the bowl shaped part 23b of the valve sheet 23. In this condition, the opening 23c in the valve seat 23 will be closed by the ball 32. When the opening 23c is closed, the fuel injection hole 24a in the orifice 24 will also be closed. The force that the ball 32 is pressed to the bowl shaped part 23b of the valve seat 23 can be adjusted by the press fit position of the adjuster 28.

The solenoid coil 18 is coaxially disposed about the core 21 adjacent to the rearward edge of the armature 31. The solenoid coil 18 is attached to the outside of the core 21. The housing 12 includes a connector 36. Electrical power is supplied to the connector 36 from an external power source. The connector has a pin 37. The pin 37 of the connector 36 and the solenoid coil 18 are connected by an electrical wire (not shown). As described above, the core 21, the valve body 14, and the armature 31 are made of ferromagnetic material, and the ring 20 is made of a nonmagnetic material. Therefore, when the solenoid coil 18 is energized, a magnetic path is formed by an upper valve body 46, valve body 14, armature 31 and core 21. The armature 31 will be attracted by the magnetic force, and the valve 25 will be retracted to the core 21 side (back end side) against the biased force of the spring 26. When the valve 25 has retracted, the upstream end surface 30 of the armature 31 (to be precise, the contact surface 44a of the plating protrusions 44) will contact with the downstream end surface 29 of the core 21. When the ball 32 of the valve 25 is in contact with the valve seat 23, there is a small gap between the upstream end surface 30 of the armature 31 and the downstream end surface 29 of the core 21. The gap is so small that, the gap is not shown in the drawing.

The back end of the core 21 protrudes out from the housing 12 and a fuel supply port 43 is open on that end. An O-ring 41 is attached to the part of the core 21 protruding from the housing 12. A stopper ring 42 which prevents the O-ring 41 from falling off is engaged in a groove farther to the back side of the position where the O-ring 41 is attached. The O-ring 41 ensures hermeticity between the fuel supply line and the fuel injector 10. The fuel supply line supplies a pressurized fuel to the fuel injector 10.

The fuel which is applied to the fuel supply port 43 of the core 21 passes through the fuel path 22 of the core 21, the fuel path 28a of the adjuster 28, the fuel path 33 of the valve 25, and the side hole 35 of the valve 25 before reaching the valve seat 23. When the ball 32 of the valve 25 and the bowl shaped part 23b of the seat 23 are in contact, the opening 23c is closed by the ball 32, and fuel will not flow out from the opening 23c. When the valve 25 is retracted, the ball 32 and the bowl shaped part 23b is separated, and fuel flows out from the opening 23c. The fuel which flows out from the opening 23c is sprayed out from the injection holes 24a in the orifice 24.

With the fuel injector 10 constructed in this manner, when power is supplied and the solenoid coil 18 is magnetized, the valve 25 will retract and the fuel will be sprayed from the fuel injection holes 24a. When the supply of power is cut off, the valve 25 will move forward, the fuel injection hole 24a will be closed, and the spray of fuel will stop.

Even if the back surface 30 of the armature 31 and the leading end surface 29 of the core 21 are in contact, fuel will enter between the back surface 30 and the leading end surface 29. When the two surfaces 29, 30 are closely attached while wetted by fuel, a kind of adhesive force will be generated between the two surfaces 29, 30. Adhesive forces increase as the contact surface area of the two surfaces 29, 30 increases. As previously described, the back surface 30 of the armature 31 has the plating protrusions 44 and the non-plating recesses 40. Therefore, the contact surface 44a of the plating protrusions 44 and the leading end surface 29 of the core 21 will be in contact when the valve 25 is retracted. Thus, the adhesive forces will be lower when the valve 25 is to move forward from the condition where only the contact surface 44a and the leading end surface 29 are in contact. When the adhesive forces are lower, the contact surface 44a will easily separate from the leading end surface 29, so the responsiveness of the fuel injector 10 will be increased.

Furthermore, when the non-plating recesses 40 are formed, fuel will easily enter the gap between the contact surface 44a and the leading end surface 29 through the non-plating recesses 40. Therefore, the contact surface 44a will more easily separate from the leading end surface 29.

The plating protrusions 44 and the non-plating recesses 40 may also be formed on the core 21 without being formed on the armature 31. Alternatively, the plating protrusions 44 and non-plating recesses 40 may be formed on both the armature 31 and the core 21. If the plating protrusions 44 and the non-plating recesses 40 are formed on both the armature 31 and the core 21, the protrusions 44 of the armature 31 and recesses 40 of the core 21 will preferably not mutually engage. For instance, mutual engagement of the recesses 40 and protrusions 44 may be prevented by adjusting the top surface area of the plating protrusions 44 and the bottom surface area of the non-plating recesses 40. Alternatively, mutual engagement of the recesses 40 and protrusions 44 may be prevented by adjusting the shape or positional relationship of the plating protrusions 44 and the non-plating recesses 40.

It is also possible to form the recesses 40 and protrusions 44 on the back surface 30 by plating the recesses 40 with a thinner plating than the plating protrusions 44.

FIG. 4 shows an example of another configuration where plating protrusions 44 and a single non-plating recesse 40 are formed on the back surface 30 of the armature 31. With this configuration, two plating protrusions 44 are concentrically formed, and a single non-plating recess 40 is formed between them. When plating protrusions 44 and a single non-plating recess 40 are formed, a damping effect will be created by the fuel which is located within the non-plating recess 40 when the valve 25 is retracted and the contact surface 44a of the plating protrusions 44 contacts with the leading end surface 29 of the core 21. When this damping effect occurs, the open valve bounce, which occurs when the valve 25 is retracted and the fuel injector 10 is opened, will be reduced. If the open valve bounce can be reduced, the fuel can be injected with even better precision.

FIG. 5 shows an example of yet another pattern of plating protrusions 44 and non-plating recesses 40. Here, a plurality of notches 45 have been added to the inside plating protrusions 44 as shown in FIG. 4. With this configuration, the open valve bounce, which occurs when the valve 25 is retracted and the contact surface 44a contacts with the leading end surface 29, can be reduced by the damping effect of the fuel which is located within the non-plating recesses 40. Furthermore, fuel will flow into the non-plating recesses 40 through the notches 45, so the adhesive forces are reduced and the contact surface 44a and the leading end surface 29 will easily separate from a condition of contact. In other words, in addition to being able to reduce the open valve bounce, the contact surface 44a will be able to easily separate from the leading end surface 29. The adhesive forces and the open valve bounce can be adjusted by selecting the appropriate size, configuration, and number of notches 45.

The configuration of the contact surface is not restricted to the configurations shown in FIG. 3, FIG. 4, and FIG. 5, and various other configurations may be used. For instance, the contact surface 44a may also be elliptical, rectangular, curved, a combination of straight and curved lines, or an enclosure formed by straight and curved lines.

Finally, although the preferred representative embodiments have been described in detail, the present embodiments are for illustrative purpose only and not restrictive. It is to be understood that various changes and modifications may be made without departing from the spirit or scope of the appended claims. In addition, the additional features and aspects disclosed herein also may be utilized singularly or in combination with the above aspects and features.

Furthermore, the technical elements described in this specification and the drawings demonstrate various technical features independently or in various combinations, and are not restricted to the combinations of claims. Furthermore, the technology presented in the specifications and drawings simultaneously achieves multiple objectives but the technology has merit even if only one of the objectives is achieved.

What is claimed:

1. A fuel injector comprising:
a valve body having a fuel path;
a valve seat attached to the downstream side of the valve body, the valve seat having a fuel injection hole;
a core attached to the valve body;
a valve slidably disposed within the valve body between a closed position and an open position, the valve having an armature on one end and a ball on the other end, wherein an upstream end surface of the armature contacts a downstream end surface of the core when the valve is in the open position, and wherein the ball closes the fuel injection hole in the valve seat when the valve is in the closed position;
a spring disposed within the valve body, the spring applying a bias force on the valve such that the valve is pushed to the closed position; and
a solenoid coil for retracting the valve from the closed position to the open position;
wherein at least one of the upstream end surface of the armature or the downstream end surface of the core is partially plated, and wherein recesses and protrusions are formed by the plated regions and non-plated regions.

2. A fuel injector according to claim 1, wherein the upstream end surface of the armature and the downstream end surface of the core each have a fuel path opening, wherein at least one of the upstream end surface of the armature or the downstream end surface of the core has a plurality of plated regions, the plated regions extending radially from the circumference of the opening to the outside edge.

3. A fuel injector according to claim 1, wherein at least one of the upstream end surface of the armature or the downstream end surface of the core has a plurality of plated regions, the each plated region being substantially ring shaped and arranged to be substantially concentric.

4. A fuel injector according to claim 1, wherein the upstream end surface of the armature and the downstream end surface of the core each have a fuel path opening, wherein at least one of the upstream end surface of the armature or the downstream end surface of the core has a plurality of plating regions, the plating regions being substantially ring shaped and arranged in substantially concentric form around the opening, and wherein at least one of the plating regions has notches extending in the radial direction.

5. A fuel injector comprising:
a valve body having a fuel path;
a valve seat attached to the downstream side of the valve body, the valve seat having a fuel injection hole;
a core attached to the valve body;
a valve slidably disposed within the valve body between a closed position and an open position, the valve having an armature on one end and a ball on the other end, wherein an upstream end surface of the armature contacts a downstream end surface of the core when the valve is in the open position, and wherein the ball closes off the fuel injection hole in the valve seat when the valve is in the closed position;
a spring disposed within the valve body, the spring applying a bias force on the valve such that the valve is pushed to the closed position; and
a solenoid coil for retracting the valve from the closed position to the open position;
wherein at least one of the upstream end surface of the armature or the downstream end surface of the core is plated, and wherein recesses and protrusions are formed by varying the thickness of the plating.

6. A fuel injector comprising:
a valve body having a fuel path;
a valve seat attached to the downstream side of the valve body, the valve seat having a fuel injection hole;
a core attached to the valve body;
a valve slidably disposed within the valve body between a closed position and an open position, the valve having an armature on one end and a ball on the other end, wherein an upstream end surface of the armature contacts a downstream end surface of the core when the valve is in the open position, and wherein the ball closes off the fuel injection hole in the valve seat when the valve is in the closed position;
a spring disposed within the valve body, the spring applying a bias force on the valve such that the valve is pushed to the closed position; and
a solenoid coil for retracting the valve from the closed position to the open position;
wherein the upstream end surface of the armature and the downstream end surface of the core have recesses and protrusions, and wherein the recesses and protrusions on the upstream end surface of the armature do not mutually engage with the protrusions and recesses on the downstream end surface of the core when the protrusions on both end surfaces are in contact.
